(19) United States
(12) Patent Application Publication
(10) Pub. No.: US 2005/0192866 A1
(43) Pub. Date: Sep. 1, 2005

(54) System and method for managing a retail marketing program utilizing dynamic forms

(75) Inventors: Albia A. DeMaranville III, Seattle, WA (US); Norman G. Haun, Issaquah, WA (US); Michael K. Hutcheson, Kenmore, WA (US); Richard A. Wyatt, Redmond, WA (US); William E. Reeves, Mukilteo, WA (US)

Correspondence Address: NIXON & VANDERHYE, P.C., 901 NORTH GLEBE ROAD, 11TH FLOOR, ARLINGTON, VA, 22203, US

(73) Assignee: Nintendo of America Inc., Redmond, WA (US)

(21) Appl. No.: 11/069,049

(22) Filed: Mar. 2, 2005

Related U.S. Application Data
(63) Continuation-in-part of application No. 09/972,191, filed on Oct. 9, 2001.
(60) Provisional application No. 60/548,871, filed on Mar. 2, 2004.
(60) Provisional application No. 60/252,900, filed on Nov. 27, 2000.
(60) Provisional application No. 60/239,093, filed on Oct. 11, 2000.

(51) Int. Cl. G06F 17/60

(52) U.S. Cl. 705/14

(57) ABSTRACT

A system and method for managing a retail marketing program utilizing a dynamic interaction forms are provided. A client computing device generates a request for a retail marketing program form. A processing server generates the requested form that includes various components for providing retail marketing program information and facilitating scenario interaction. The client computing device obtains the generated form and can provide additional interaction information to the processing server.

### CROSS-REFERENCE TO RELATED APPLICATIONS

This application claims the benefit of U.S. Provisional Application No. 60/548,871, entitled SYSTEM AND METHOD FOR MANAGING A RETAIL MARKETING PROGRAM, and filed on Mar. 2, 2004. U.S. Provisional Application No. 60/548,871 is incorporated by reference herein.

This application is also a continuation-in-part of U.S. application Ser. No. 09/972,191 filed Oct. 9, 2001 which claims the benefit of U.S. Provisional Application Nos. 60/252,900 filed Nov. 27, 2000 and 60/239,093 filed Oct. 11, 2000. The contents of U.S. application Ser. Nos. 09/972,191, 60/252,900 and 60/239,093 are incorporated by reference herein.

### TECHNICAL FIELD

In general, the technology described herein relates to computer software and communication networks, and, in particular, to a system and method for facilitating the management of a retail marketing program in a networked environment by utilization of interactive, dynamic retail marketing program forms.

### BACKGROUND

Generally described, retail marketing programs correspond to incentives, in the form of funds and materials, that manufacturers provide to retailers and distributors (herein “retailers”) to promote the manufacturer's goods. For example, a manufacturer may be willing to reimburse a retailer for running advertisements within local media outlets. Additionally, the manufacturer may be willing to provide funds/materials (such as posters) to promote the manufacturer's goods within retailer's stores. Typically, the amount of funds/materials provided to the retailers corresponds to product sale volumes provided by the retailer. Accordingly, the typical retail marketing program requires interaction by the manufacturer with various authorized retailers.

Retail marketing programs typically rely on a set of metrics that are used to determine the funds/materials available to each retailer. Additionally, retail marketing programs typically utilize defined criteria for reimbursing retailers/distributors for various marketing expenditures. Accordingly, a retail marketing program for a manufacturer promoting a variety of products and/or utilizing a wide variety of retailers can become complex to manage.

One conventional approach to managing a retail marketing plan includes the manual management of the programs available to each retailer and claims made by each retailer. For example, one conventional approach to manually managing each retailer corresponds to the creation and updating of a physical worksheet for each retailer that outlines various information related to each retailer. In one aspect, although the conventional manual approach attempts to consolidate the potentially relevant information, this approach can become deficient in that it requires each worksheet to be manually created and updated. Accordingly, the worksheet typically does not reflect any data modified since the last update of the worksheet. Further, the worksheet approach typically cannot provide any type of dynamic interaction that allows retailers to submit information and/or provide hypothetical scenarios.

Accordingly, there is a need for a system and method for managing a retail marketing program in a networked environment that facilitates interaction in a distributed network.

### SUMMARY OF PRESENT EXEMPLARY NON-LIMITING EMBODIMENTS

A system and method for managing a retail marketing program utilizing dynamic interaction forms are provided. A client computing device generates a request for a retail marketing program form. A processing server generates the requested form that includes various components for providing retail marketing program information and facilitating scenario interaction. The client computing device obtains the generated form and can provide additional interaction information to the processing server.

In accordance with an exemplary non-limiting embodiment, a computer-readable medium having computer-executable components for managing a retail marketing program is provided. The computer-executable components include a product identification component for identifying products included in a retail marketing program, and a scenario calculations component for facilitating user input of data relating to each of the products identified by the product identification component. The product identification component and the scenario calculations component form a single page view. This single page view may also include a version identification component for identifying a version of the retail marketing program form, and a dynamic details component including identification of activities corresponding to a component of the retail marketing program. The scenario calculations component may include one or more fields for facilitating user input of the data relating to each of the identified products, the fields including a field for facilitating user input of the number of projected units of each identified product for a fiscal year and/or an average unit cost for each identified product. The scenario calculations component may also include fields for facilitating user input of the number of projected units for each of a plurality of subcategories of the identified products and/or a field for facilitating user input of an average unit cost for each of a plurality of subcategories of the identified products.

In accordance with another exemplary non-limiting embodiment, a method for managing a retail marketing program is provided. In accordance with the method, a processing server receives a request from a client computing device for a retail marketing program form. The processing server obtains current retail marketing program information corresponding to the client computing device request. The processing server then generates a retail marketing program form. The retail marketing program form includes a product identification pane for identifying products included in the retail marketing program and a scenario calculations pane for facilitating user input of data relating to each of the products identified in the products identification pane. The processing server transmits the retail marketing program form including the product identification pane and the scenario calculations pane to the client computing device. The scenario calculations pane may facilitate user input of the number of projected units and/or average unit costs for each of the identified products and/or a plurality of subcategories of the identified products.

### BRIEF DESCRIPTION OF THE DRAWINGS

The foregoing aspects and many of the attendant advantages of present exemplary non-limiting embodiments will become more readily appreciated as the same become better understood by reference to the following detailed description, when taken in conjunction with the accompanying drawings, wherein:

FIG. 1 is a block diagram illustrative of a retail marketing program system including one or more client computing devices, a processing server, a retail marketing program data store and a management computing device in accordance with an exemplary non-limiting embodiment;

FIG. 2A is a block diagram of the retail marketing program system of FIG. 1 illustrating the generation of a dynamic retail marketing program form between a client computing device and the processing server in accordance with an exemplary non-limiting embodiment;

FIG. 2B is a block diagram of the retail marketing program system of FIG. 1 illustrating the generation of a revised retail marketing program form between a client computing device and the processing server in accordance with an exemplary non-limiting embodiment;

FIG. 3 is a flow diagram illustrative of a retail marketing program form processing routine implemented by a processing server in accordance with an exemplary non-limiting embodiment; and

FIGS. 4A-4C are illustrative of screen displays corresponding to a dynamic retail marketing program form formed in accordance with an exemplary non-limiting embodiment.

### DETAILED DESCRIPTION OF EXEMPLARY NON-LIMITING EMBODIMENTS

Generally described, the exemplary non-limiting embodiments relate to a system and method for implementing a retail marketing program in a networked environment. More specifically, the present invention corresponds to a system and method for facilitating dynamic interaction between the retail marketing program system and a plurality of clients. Although the present invention will be described with regard to information and screen displays of an illustrative retail marketing program, the disclosed embodiments are illustrative in nature and should not be construed as limiting.

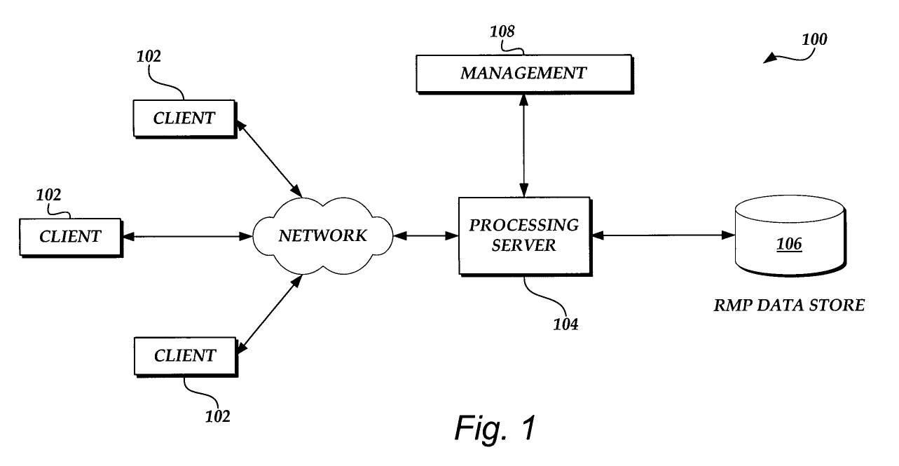

With reference to now to FIG. 1, an illustrative retail marketing program system 100 will be described. The retail marketing program system 100 can include a plurality of client computing devices 102 in communication with a communication network, such as the Internet or local area network. Each client computing device 102 can correspond directly to a retailer in the retail marketing program. Alternatively, the client computing device 102 can also correspond to a representative of the retail marketing program system 100. For example, the retail marketing system 100 can utilize a plurality of sales associates/representatives that visit retailers and provide information regarding their participation in the retail marketing program.

The retail marketing program system 100 can also include a processing server 104 in communication with the plurality of client computing devices 102 via the communication network. The processing server 104 can include one or more computing devices configured to carry out the various functions of the processing server. The computing devices associated with the processing server 104 may correspond to a centralized location or alternatively, be configured in a distributed manner. The processing server 104 communicates with a retail marketing program data store 106. The retail marketing program data store 106 can correspond to one or more data repositories for maintaining information relevant to the retail marketing program, such as specific retailer participation information. The retail marketing program data store 106 may be distributed over various data stores and/or storage systems.

Also in communication with the processing server 104 is a management computing device 108 corresponding to one or more personnel that manage the retail marketing program. Although only a single management computing device 108 is illustrated, one skilled in the relevant art will appreciate that the management computing device 108 can correspond to any number of computing devices for managing the retail marketing program. One skilled in the relevant art will appreciate that the various computing devices described for the retail marketing program system 100 can include personal computers, server computers, hand-held computers, mobile computers, mobile telephones, personal digital assistants, and the like. Likewise, although the retail marketing program system 100 is illustrated as in a client/server configuration, one skilled in the relevant art will appreciate that the retail marketing program system may also be implemented in a peer-to-peer configuration.

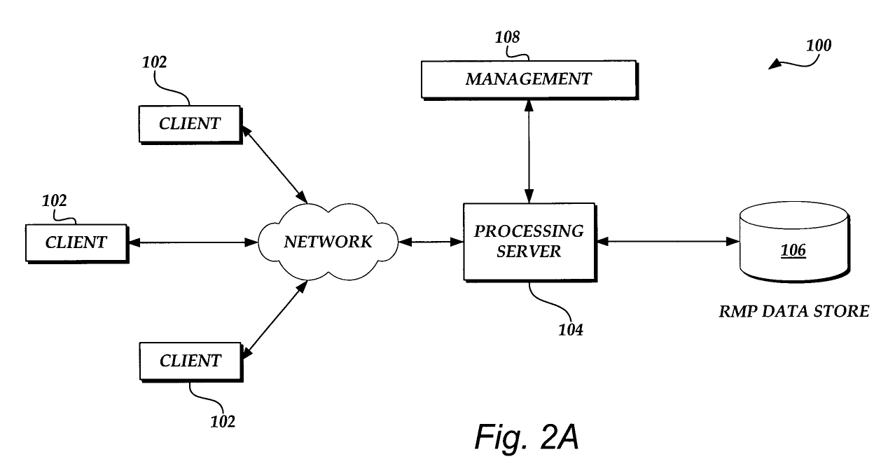

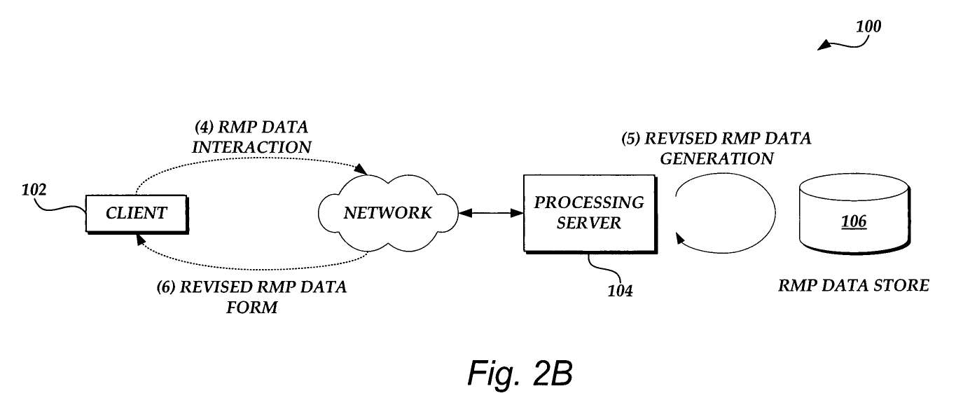

With reference now to FIGS. 2A and 2B, the processing server 104 and the client computing devices 102 communicate as part of a two-way dynamic interaction of retail marketing program information corresponding to the retail marketing program. More specifically, the processing server 104 and client computing device 102, can dynamically exchange information to update current participation information in the retail marketing program and/or conduct hypothetical interactions in accordance with the retail marketing program. With reference now to FIG. 2A, the client computing device 102 requests retail marketing program information from the processing server 104. In an illustrative non-limiting embodiment, the request for the retail marketing program information may correspond to a manually configured request. Alternatively, the request can correspond to a scheduled request or based upon the evaluation of criteria. For example, a client computing device 102 may generate a request once a threshold amount of business activity has been accrued.

The processing server 104 obtains the request and dynamically obtains relevant information from the retail marketing program data store 106. The processing server 104 can then generate a corresponding retail marketing program form, which will be described in greater detail below. In an illustrative non-limiting embodiment, the processing server may include any updated retail marketing program information included with the client request. Alternatively, the processing server 104 may periodically generate retail marketing program forms for pre-calculated responses to client requests. Upon generation of the retail marketing program information, the processing server 104 delivers the information to the requesting client computing device 102 and any additional authorized client computing devices.

With reference now to FIG. 2B, as part of the dynamic interaction with the processing server 104, the client computing device 102 can generate additional retail marketing program information. The additional retail marketing program information can correspond to updated information corresponding to the retailer's participation in the retail marketing program. Additionally, the additional retail marketing program information can correspond to various hypothetical scenarios related to the retailer's participation in the retail marketing program. The processing server 104 obtains the additional retail marketing program information and includes any updated retail marketing program information included with the additional client request. The processing server 104 then generates a revised retail marketing program form and transmits the form to the requesting client computing device 102. The revised retail marketing program form information may be saved in the retail marketing program data store 106 as a different version for various scenario based comparisons. The process illustrated in FIG. 2B may be repeated.

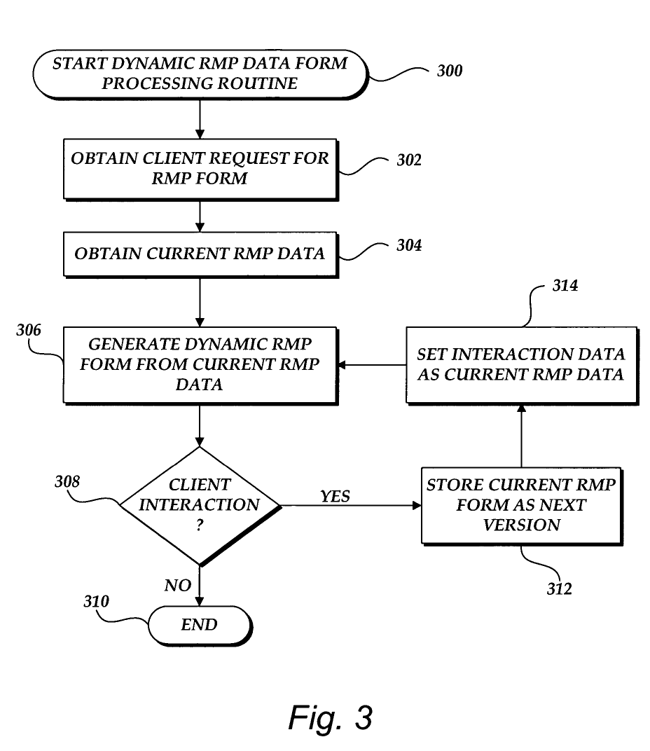

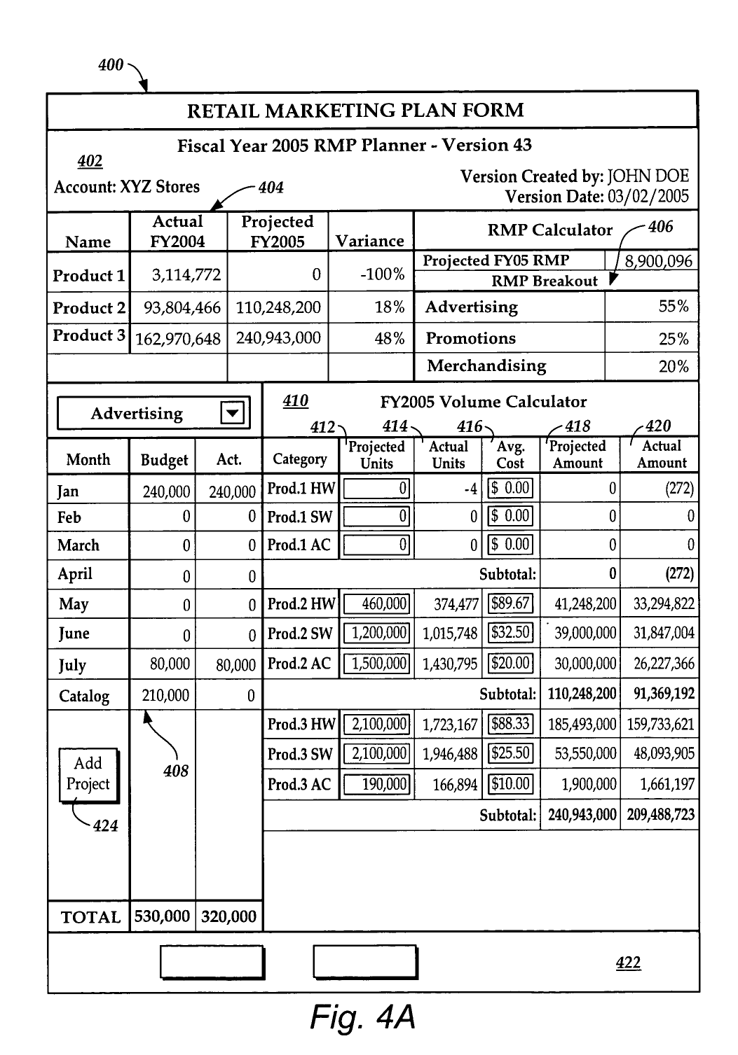

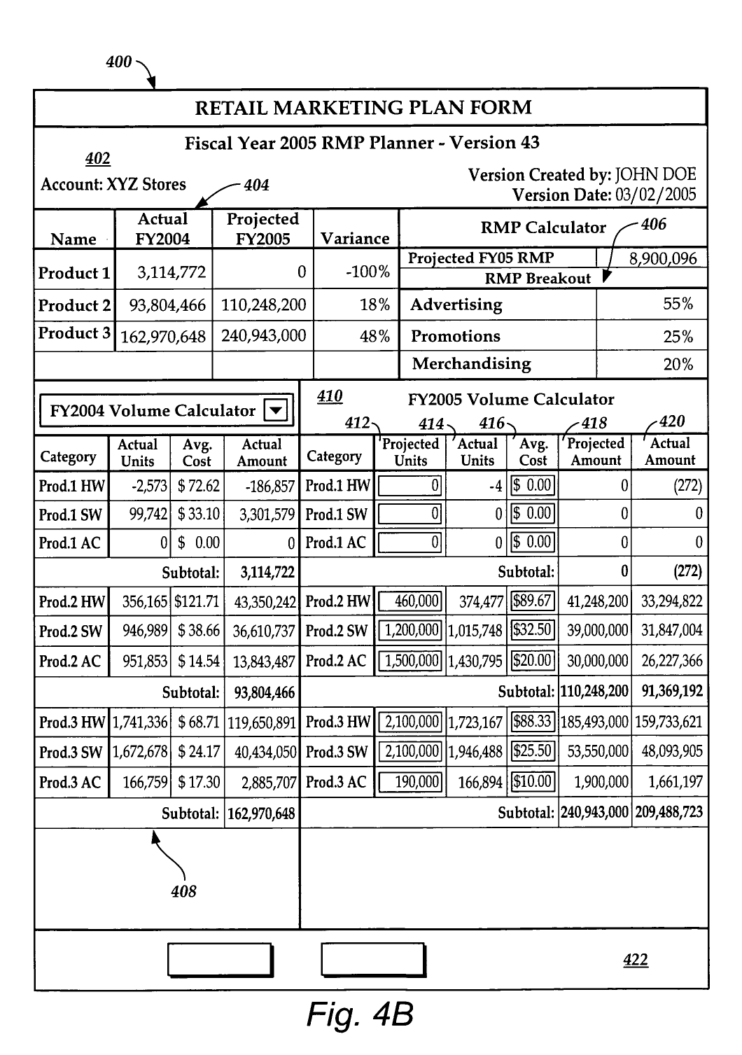

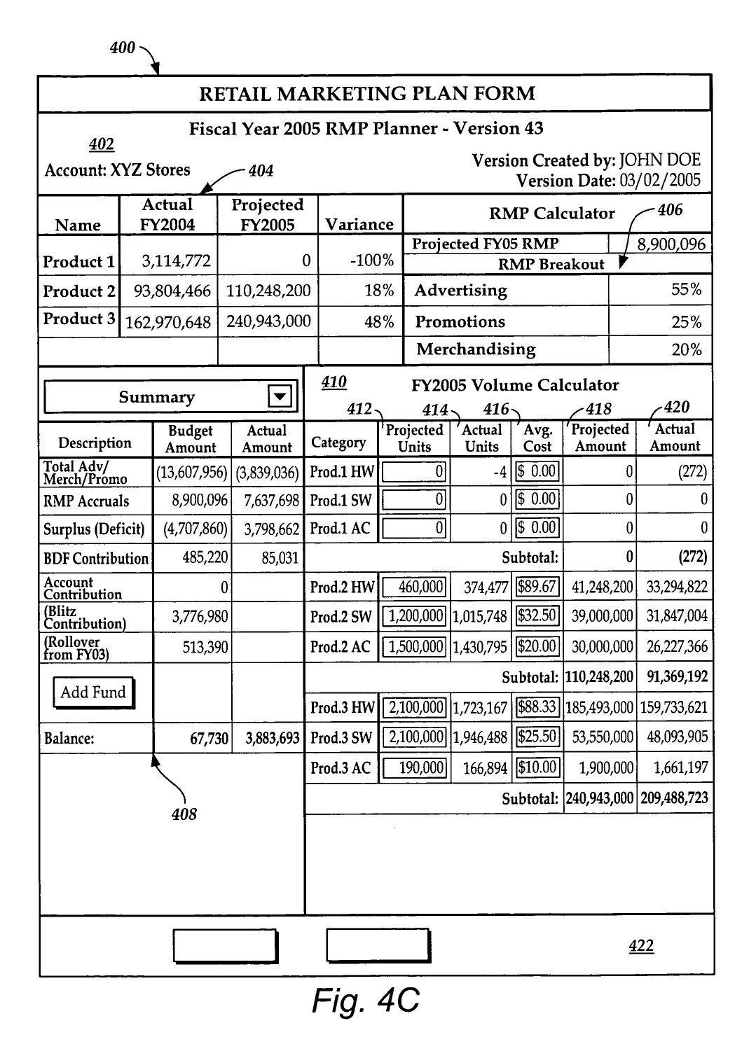

With reference now to FIG. 3, a dynamic retail marketing program form processing routine 300 will be described. At block 300, the processing server 104 obtains a request for a retail marketing program form. In an illustrative non-limiting embodiment, the request can correspond to a manual request for information. Alternatively, the request can correspond to a regularly scheduled form request or a request based upon evaluation of various criteria. At block 304, the processing server 104 obtains current retail marketing program data from the retail marketing program data store 106. In an illustrative non-limiting embodiment, the processing server 104 may store some of the relevant retail marketing program data locally, such as a system cache. At block 306, the processing server 104 generates a dynamic retail marketing program form from the current retail marketing program data. FIGS. 4A-4C, described below, are screen shots of an illustrative retail marketing program form.

At decision block 308, a test is conducted to determine whether there is any additional client computing device interaction. If there is no additional client computing device interaction, the routine 300 terminates at block 310. If there is additional client computing device interaction, at block 312, the processing server 104 stores the current version of the retail marketing program form as the next version of the form. At block 314, the processing server 104 associates updates the previously obtained retail marketing program information with the interaction information and returns to block 304 to generate an updated retail marketing program form. In one aspect, the interaction information can include updated retail marketing program information associated with the most current data from the retailer. In another aspect, the interaction information can include various hypothetical information designed to generate possible outcomes for a retailer. In an illustrative non-limiting embodiment, the client computing device 102 may maintain local copies of the retail marketing program form to facilitate off-line interaction. Upon receiving a designation, the client computing device 102 may transmit interaction information to the processing server 104.

With reference now to FIGS. 4A-4C, various screen interfaces 400 generated by the processing server 104 and corresponding to illustrative retail marketing program forms will be described. In accordance with an exemplary non-limiting embodiment, the screen interfaces 400 facilitate the placement of retail marketing information in a single viewing page. Further, the screen interfaces 400 facilitate the entry and/or modification of the retail marketing program information by the client computing device 102 that can be transmitted to the processing server 104. The screen interfaces 400 further facilitate the delivery of multiple versions of the information for comparisons and/or hypothetical interactions by the client computing device 102. One skilled in the relevant art will appreciate that the screen interfaces 400 may be generated utilizing markup languages, such as Hypertext Markup Language (“HTML”) and Extensible Markup Language (“XML”).

With reference to FIG. 4A, the screen interface 400 can be arranged to display various retail marketing program information in different panes within the interface. In a first pane 402, the screen interface 400 can include retail marketing form version information. As illustrated in FIG. 4A, the version information can include a version number (version number “43” in the example illustrated in FIG. 4A), a version creation date (date “Mar. 2, 2005” in the example illustrated in FIG. 4A) and/or version creator/author (“John Doe” in the example illustrated in FIG. 4A). The screen interface 400 can also include a product details pane 404. In an illustrative non-limiting embodiment, the product details pane 404 identifies all the products provided by the manufacturer that correspond to the retail marketing program (or at least all of the manufacturer products corresponding to the retail marketing program for the identified account which is “XYZ stores” in the example illustrated in FIG. 4A). The product details pane 404 can also include information identifying volumes for each product (products 1-3 in the example illustrated in FIG. 4A) for the previous fiscal year (FY2004 in the example illustrated in FIG. 4A), projected volumes for the current/upcoming fiscal year (FY2005 in the example illustrated in FIG. 4A) and percentage variances from the two volumes.

The screen interface 400 can also include retail marketing program details pane 406. The retail marketing program details pane 406 includes information identifying all the marketing activities associated with a retail marketing program for a particular account and the percentage breakdown of funds attributed to each marketing activity. For example, typical marketing activities can include advertising, promotions and merchandising. The screen interface 400 also includes a dynamic details pane 408 for providing the client computing device 102 with various details regarding the retailer's participation in the retail marketing program. For example, FIG. 4A illustrates a breakdown of all activities corresponding to a first retail marketing program activity, such as advertisements. The information can include activities organized by month and budgets for other activities (e.g., “catalog” illustrated in FIG. 4A) and can also include budgeted amounts and actual amounts. With reference to FIG. 4B, the dynamic details pane 408 can also include the previous year's (FY2004 in the example illustrated in FIG. 4B) fiscal volume calculations. In this embodiment, the volumes are organized by products (Products 1-3 in the example illustrated in FIG. 4B), including product subcategories ((a) Product 1 Hardware (HW), Software (SW) and accessories (AC), (b) Product 2 Hardware (HW), Software (SW) and accessories (AC), (c) Product 3 Hardware (HW), Software (SW) and accessories (AC) in the example illustrated in FIG. 4B). The volume data may be organized actual unit sales, average unit cost and net amount accrued for the retail marketing program. With reference now to FIG. 4C, the dynamic details pane 408 can further include a retail marketing program summary. In this embodiment, the retail marketing summary can include marketing activities totals, retail marketing plan accrual totals, comparison of activities to accruals (surplus), additional contributions and account balances. The dynamic details pane 408 can be manipulated to display different detail information through the manipulation of pull down menus or other user controls. For example, with reference to FIG. 4A, the user may select the “Add Project” button 424 which will activate the processing server 104 to generate for display another screen interface which allows user input to identify another project (e.g., in addition to “Catalog”) and a budgeted amount of money for that project. The entered project and budgeted amount is transmitted to the processing server 104 and stored in the RMP data store 106. The newly entered project and budgeted amount will be displayed on dynamic details pane 408 when it is refreshed. One skilled in the relevant art will appreciate that additional retail marketing program information may also be included in the dynamic details pane.

With reference again to FIG. 4A, the screen interface 400 can include scenario calculations pane 410 for generating various product volume scenarios. The scenario calculations pane 410 includes various columns for allowing users to input various volume calculation factors to determine the effect on retail marketing program accruals. Similar to the dynamic details pane 408 of the previous year's fiscal volume calculations, the scenario calculations pane 410 is organized according product (and subcategories of each product). As illustrated in FIG. 4A, column 412 in the scenario calculations pane 410 allows for the specification of various projected units for each product and product subcategory, while column 414 facilitates comparison of this projected current unit volume to actual current unit volume. The scenario calculations pane 410 also allows for the specification of average unit cost for each product and product subcategory in column 416 and providing projected product amount calculations in column 418. The scenario calculations pane 410 can further include actual accrued amounts in column 420. The screen interface 400 can further include a control pane 422 for facilitating interaction with the processing server 104, such as storing form version or clearing the scenario calculations pane 410.

The scenario calculations pane 410 therefore allows the user to input a number or change an existing number for projected units for each product (e.g., number of projected units sold) and product subcategory for a particular time period (e.g., fiscal year 2005) in column 412. The scenario calculations pane 410 also allows the user to input a number or change an existing number for an average unit cost (expense) for each product and product subcategory in column 416. Multiple fields (projected number of units for the current fiscal year and average cost for a single unit) may thus be entered by the user in the scenario calculations pane 410 for each product and product subcategory. The projected product amount in column 418 is calculated by multiplying the user-entered or modified numbers in columns 412 and 416 for each product and product subcategory. This calculation enables easy comparison to the actual accrued amounts in column 420 for each product and product subcategory. The projected amount in column 418 for the subcategories for each product is summed and displayed as a “subtotal” for that product. Projected units and average unit costs of product subcategories can be added together to indicate the total number of projected units and total average cost for that product. The projected amount in column 418 may also be multiplied by a percentage to calculate a projected amount of retail marketing plan credit (e.g., funds or materials) earned by a particular retailer's account to promote the manufacturer's goods. A projected amount of credit for marketing activities such as advertising, promotions, merchandising that is earned by a retailer in the retail marketing program thus corresponds to the projected amounts in column 418.

While illustrative embodiments of the invention have been illustrated and described, it will be appreciated that various changes can be made therein without departing from the spirit and scope of the invention.

1. A computer-readable medium having computer-executable components for managing a retail marketing program, the computer-executable components comprising:
a product identification component for identifying products included in a retail marketing program; and
a scenario calculations component for facilitating user input of data relating to each of the products identified by the product identification component;
wherein the product identification component and the scenario calculations component form a single page view.

2. The computer-readable medium as in claim 1, wherein the computer-executable components further comprise: a version identification component for identifying a version of a retail marketing program form.

3. The computer-readable medium as in claim 1, wherein the computer-executable components further comprise: a dynamic details component for identifying details corresponding to aspects of the retail marketing program.

4. The computer-readable medium as in claim 1, wherein the computer-executable components further comprise:
a version identification component for identifying a version of a retail marketing program form; and
a dynamic details component for identifying details corresponding to aspects of the retail marketing program;
wherein the version identification component, product identification component, dynamic details component and scenario calculations component form a single page view.

5. The computer-readable medium as in claim 1, wherein the scenario calculations component includes a field for facilitating user input of the data relating to each of the identified products, the field facilitating user input of the number of projected units of each of the identified products.

6. The computer-readable medium as in claim 1, wherein the scenario calculations component includes a field for facilitating user input of the data relating to each of the identified products, the field facilitating user input of an average unit cost for each of the identified products.

7. The computer-readable medium as in claim 1, wherein the scenario calculations component includes multiple fields for facilitating user input of the data relating to each of the identified products, wherein the fields including a field for user input of the number of projected units and another field for an average unit cost for each of the identified products.

8. The computer-readable medium as in claim 1, wherein the scenario calculations component includes a field for facilitating user input of the data relating to each of the identified products, the field facilitating user input of the number of projected units for at least one subcategory of the identified products.

9. The computer-readable medium as in claim 1, wherein the scenario calculations component includes a field for facilitating user input of the data relating to each of the identified products, the field facilitating user input of an average unit cost for at least one subcategory of the identified products.

10. The computer-readable medium as in claim 1, wherein the scenario calculations component includes multiple fields for facilitating input of the data relating to each of the identified products, the fields including a field for user input of the number of projected units and another field for an average unit cost for at least one subcategory of the identified products.

11. A method for managing a retail marketing program, the method comprising:
receiving a request from a client computing device for a retail marketing program form;
obtaining current retail marketing program information corresponding to the client computing device request;
generating a retail marketing program form including a product identification pane for identifying products included in the retail marketing program and a scenario calculations pane for facilitating user input of data relating to each of the products identified in the product identification pane; and
transmitting the retail marketing program form to the client computing device.

12. The method as in claim 11, wherein the retail marketing program form further includes a version identification pane for identifying a version of the retail marketing program form.

13. The method as in claim 11, wherein the retail marketing program form further includes a dynamic details pane for identifying details corresponding to aspects of the retail marketing program.

14. The method as in claim 11, wherein the retail marketing program form further includes a version identification pane for identifying a version of the retail marketing program form and a dynamic details pane for identifying details corresponding to aspects of the retail marketing program, wherein the version identification pane, product identification pane, dynamic details pane and scenario calculations pane form a single page view.

15. The method as in claim 11, wherein the scenario calculations pane includes a field for facilitating user input of the data relating to each of the identified products, the field facilitating user input of the number of projected units of each identified product.

16. The method as in claim 11, wherein the scenario calculations pane includes a field for facilitating user input of the data relating to each of the identified products, the field facilitating user input of the average unit cost for each of the identified products.

17. The method as in claim 11, wherein the scenario calculations pane includes multiple fields for facilitating user input of the data relating to each of the identified products, wherein the fields include a field for user input of the number of projected units and an another field for an average unit cost for each of the identified products.

18. The method as in claim 11, wherein the scenario calculations pane includes a field for facilitating user input of the data relating to each of the identified products, the field facilitating user input of the number of projected units for at least one subcategory of the identified products.

19. The method as in claim 11, wherein the scenario calculations pane includes a field for facilitating user input of the data relating to each of the identified products, the field facilitating user input of an average unit cost for at least one subcategory of the identified products.

20. The method as in claim 11, wherein the scenario calculations pane includes multiple fields for facilitating user input of the data relating to each of the identified products, the fields including a field for user input of the number of projected units and another field for an average unit cost for at least one subcategory of the identified products.

21. A system for implementing a retail marketing program, the system comprising:
means for receiving a request from a client computing device for a retail marketing form;
means for obtaining current marketing program information corresponding to the request from the client computing device;
means for generating a retail marketing program form identifying products included in the retail marketing program and facilitating user input of at least one of a number of projected units and an average unit cost for each of the identified products; and
means for transmitting the retail marketing program form to the client computing device.

22. The system of claim 21, wherein the retail marketing program form facilitates user input of at least one of a number of projected units and an average cost for at least one subcategory of the identified products.
